(19) United States
(12) Patent Application Publication
(10) Pub. No.: US 2008/0124169 A1
(43) Pub. Date: May 29, 2008

(54) Releasable Coupling

(75) Inventors: Thomas Paul Suddaby, Newent (GB); Sean Patrick Nelson, Wrexham (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Specmat Limited, Kingsland, Leominster, Herefordshire (GB)

(21) Appl. No.: 11/908,396

(22) PCT Filed: Apr. 4, 2006
(86) PCT No.: PCT/GB06/01240

§ 371 Date: Oct. 4, 2007

(30) Foreign Application Priority Data
Apr. 5, 2005 (GB) 0506893.7

(51) Int. Cl. F16B 7/04; F16B 39/32

(52) U.S. Cl. 403/374.1

(57) ABSTRACT

Apparatus (30) for attaching an elongate member (18) to a rigid member (20), comprising a first part (40) with a body (42) for attachment to the rigid member (20), the body (42) defining a bore (46) for slidably receiving an end of the elongate member (18), a second part (60) having an aperture—(62) for receiving therethrough an end of the elongate member (18), the first (40) and second (60) parts having mating screw threads (70) for releasably attaching the parts together with the aperture (62) registered with the bore (46), a collet member (50) for engaging the elongate member (18). when received in the bore (46), with at least one part being configured to constrict the collet member (50) as the parts are releasably attached together, and a coupling (80), additional to the mating screw threads (70), for providing a force to resist rotation of one part relative to the other at least when the parts are attached together.

### TECHNICAL FIELD

The present invention relates to a releasable coupling, particularly but not exclusively, for releasably coupling one rigid elongate member to another rigid member.

### BACKGROUND ART

The present applicants have been designing a new modular wheelchair of the kind shown in FIG. 1, which makes repeated use of moulded and extruded components. Releasable couplings are required to couple together one extrusion to another component. A releasable coupling with mating screw threads which constrict a collet member has been proposed for securely retaining one end of such an extrusion. Whilst the releasable coupling initially functions as intended, the present applicant has found that such an arrangement is prone to working loose over time.

### DISCLOSURE OF INVENTION

According to the present invention, there is provided apparatus for attaching an elongate member to a rigid member, comprising: a first part comprising a body for attachment to the rigid member, the body defining a bore for slidably receiving an end of the elongate member; a second part having an aperture for receiving therethrough an end of the elongate member, the first and second parts having mating screw threads for releasably attaching the parts together with the aperture registered with the bore; and a collet member for engaging the elongate member when received in the bore, with at least one part being configured to constrict the collet member as the parts are releasably attached together; characterised by a coupling, additional to the mating screw threads, for providing a force to resist rotation of one part relative to the other at least when the parts are attached together.

The present applicant has appreciated that the inherent frictional resistance between the mating screw threads when the parts are attached together is not necessarily sufficient to retain securely the elongate member in the apparatus over long periods. The coupling may be operable to lock the parts together to prevent accidental or unintentional relative movement of the parts once releasably attached together, or may provide a braking force to bias one part against rotating relative to the other part.

The elongate member may be an extrusion, and may have a circular cross-section or even a non-circular cross section (e.g. cruciform). The rigid member may be plate like, or may even be an extrusion itself. When the apparatus is in use, the elongate member may be held in the bore of the body of the first part by the collet member. By releasing the second part from the first part, the collet member is no longer constricted and its grip on the elongate member is relaxed.

The coupling may comprise a protuberant member mounted on one part (e.g. first part) and configured to engage a surface of the other part at least when the parts are releasably attached together. The protuberant member may be configured as a cantilevered beam. The cantilevered beam may be resiliently flexible, with beam flexure being capable of providing a force urging a tip of the beam against the surface when the parts are being releasably attached together.

The surface may have at least one recess for receiving a tip of the protuberant member when the parts are releasably attached together. The tip of the protuberant member may be a snug fit in the at least one recess when registered therewith. In this way, relative rotation of one part relative to the other is resisted at least until the tip is no longer registered in the recess. The surface may be ribbed, with one recess being defined between each pair of adjacent ribs. Such ribbing may allow a user to obtain a firmer grip when rotatably attaching/detaching the parts, particularly if the ribbing is aligned substantially perpendicular to the direction of rotation the screw threads engage/disengage. Such ribbing may also provide a plurality of circumferentially spaced recesses for sequential engagement by the tip as the parts are rotatably attached together.

The bore in the body of the first part may be a blind bore. The bore in the body may have a profile for engaging a corresponding profile on the elongate member. The profiles may be configured such that, when inter-engaged, the elongate member is aligned in a pre-determined orientation about its longitudinal axis relative to the first part. This may be helpful when the elongate member is part of an armrest which is releasably coupled to a chair (e.g. a wheelchair). The profiles may also be configured to limit how far the end of the elongate member is insertable in the bore. Again, this may be helpful when the elongate member is part of an armrest and the height of the armrest relative to its chair is important. One or other of the profiles may be adjustable to vary depth of insertion of the elongate member in the bore.

The collet member may be integrally formed in the body of the first part, and may define at least part of the bore. The second part may include a tapered surface for constricting the collet member as the two parts are coupled together.

### BRIEF DESCRIPTION OF DRAWINGS

An embodiment of the invention will now be described, by way of example, and with reference to the accompanying Figures in which:

FIG. 1 is a perspective view of a wheelchair framework employing releasable couplings according to an embodiment of the present invention;

FIG. 2 shows an exploded perspective view of apparatus embodying the present invention; and

FIG. 3 shows a cross-sectional view of the apparatus of FIG. 2 as assembled.

### DESCRIPTION OF EMBODIMENT OF INVENTION

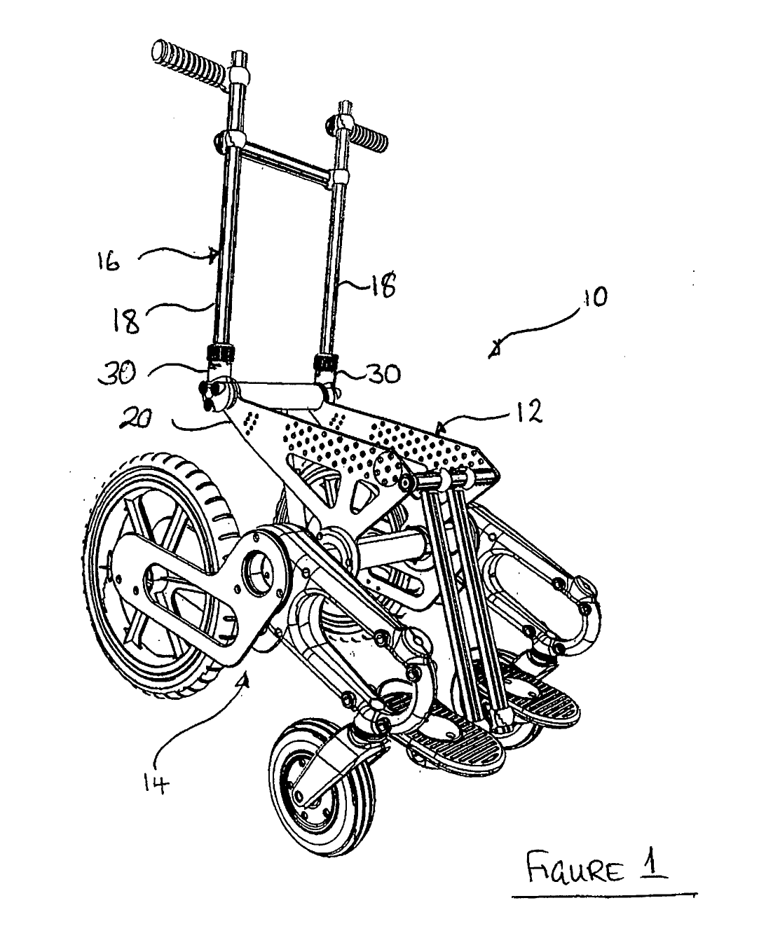

FIG. 1 shows a wheelchair (10) comprising a seat frame (12) mounted on a chassis (14). The seat framework (12) includes a backrest (16) comprising a pair of upright elongate members (18). Each upright elongate member (18) is releasably coupled to a seat platform (20) by a bracket (30). The bracket (30) may be used elsewhere on the wheelchair (10), e.g. bracket (30) may be used to couple an armrest (not shown) to seat platform (20).

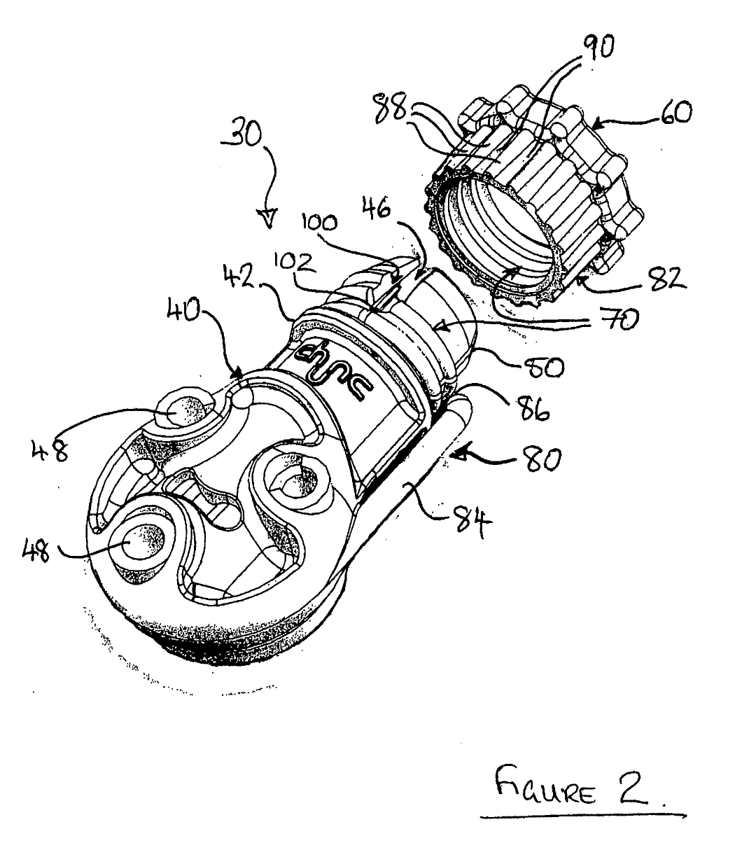

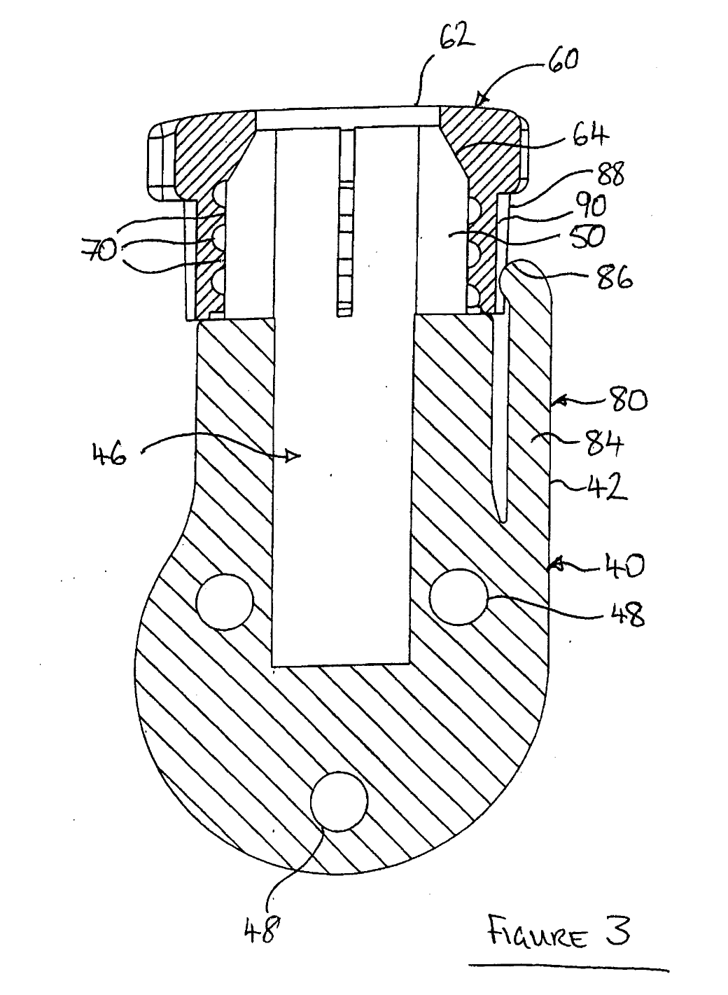

FIGS. 2 and 3 show the bracket (30) in more detail, as used to couple upright elongate member (18) to seat platform (20). The bracket (30) comprises a first part (40) and a second part (60). The first part (40) includes a body (42) defining a blind bore (46) for receiving an end of elongate member (18). The body (42) is bolted with bolts extending through holes (48) to seat platform (20), and includes a collet member (50) defining part of bore (46). The second part (60) has an aperture (62) through which an end of the elongate member (18) is a sliding fit. The first and second parts (40,60) have mating screw threads (70) for releasably attaching one part to the other, with the aperture (62) in registration with bore (46). As the mating screw threads (70) are tightened, tapered surface (64) in the second part (60) urges the collet member (50) to constrict. In this way, an end of elongate member (18) may be gripped by the collet member (50).

The first part (40) includes a coupling (80)—additional to the mating screw threads (70)—for engaging an outer peripheral surface (82) of the second part (60). The coupling (80) comprises cantilevered beam member (84) with a tip (86). The outer peripheral surface (82) of the second part (60) has ribs (88), with a recess (90) defined between each adjacent pair of ribs (88). The cantilevered beam member (84) is resiliently flexible and configured such that tip (86) fits snugly in one of the recesses (90) when the parts are attached together. Once the tip (86) is snugly received in a recess (90), relative rotation of the parts (40,60) requires the cantilevered beam member (84) to flex, and this flexure provides a force resisting further rotation of the parts (40,60).

The bore (46) in the body (42) of the first part (40) includes a groove (100) for slidably receiving a protuberant bolt (not shown) on one end of elongate member (18). When the bolt is received in the groove (100), the relative orientation of the elongate member (18) to the first part (40) cannot vary. A predetermined rotational orientation may be useful, e.g. when securing armrest using bracket (30). The protuberant bolt may be removed and inserted in a different position along the elongate member (18). In this way, the bolt may engage a stop or end (102) in the groove (100), before an end of elongate member (18) reaches the bottom of blind bore (46).

1. Apparatus for attaching an elongate member to a rigid member, comprising:
a first part comprising a body for attachment to the rigid member, the body defining a bore for slidably receiving an end of the elongate member;
a second part having an aperture for receiving therethrough an end of the elongate member, the first and second parts having mating screw threads for releasably attaching the parts together with the aperture registered with the bore; and
a collet member for engaging the elongate member when received in the bore, with at least one part being configured to constrict the collet member as the parts are releasably attached together; characterised by a coupling, additional to the mating screw threads, for providing a force to resist rotation of one part relative to the other at least when the parts are attached together.

2. Apparatus according to claim 1, in which the coupling comprises a protuberant member mounted on one part and configured to engage a surface of the other part at least when the parts are releasably attached together.

3. Apparatus according to claim 2, in which the protuberant member is resiliently flexible, and configured to flex through contact with the surface as the parts are releasably attached together.

4. Apparatus according to claim 2, in which the surface has at least one recess for receiving a tip of the protuberant member when the parts are releasably attached together.

5. Apparatus according to claim 4, in which the surface is ribbed, with one recess being defined between each pair of adjacent ribs.

6. Apparatus according to claim 1, in which the body is a blind bore.

7. Apparatus according to claim 1, in which the bore has a profile for engaging a corresponding profile on the elongate member.

8. Apparatus according to claim 7, in which the bore profile comprises a groove for slidably receiving a protuberance mounted on the elongate member.

9. Apparatus according to claim 1, in which the collet member is coupled to the first part and defines at least a portion of the bore.

10. Apparatus according to claim 9, in which the second part includes a tapered surface for urging the collet member into the bore as the two parts are attached together.
